(19) United States
(12) Patent Application Publication
(10) Pub. No.: US 2025/0340768 A1
(43) Pub. Date: Nov. 6, 2025

(54) DUST SUPPRESSION MATERIAL WITH A CROSSLINKED NETWORK STRUCTURE AND ITS PREPARATION METHOD

(71) Applicant: SHANDONG UNIVERSITY OF SCIENCE AND TECHNOLOGY, Qingdao (CN)

(72) Inventors: Haiming YU, Qingdao (CN); Yao XIE, Qingdao (CN); Han YUN, Qingdao (CN); Wang LI, Qingdao (CN)

(21) Appl. No.: 18/957,552

(22) Filed: Nov. 22, 2024

(30) Foreign Application Priority Data
May 6, 2024 (CN) 202410550510.X

(51) Int. Cl. C09K 3/22

(52) U.S. Cl. CPC C09K 3/22

(57) ABSTRACT

The present disclosure discloses a dust suppression material with a crosslinked network structure and its preparation method. The dust suppression material comprises: 16-20 parts of the cassava starch, 0.2-0.6 parts of the polyvinyl alcohol, 0.1-0.5 parts of the carboxymethyl cellulose, 0.1-0.5 parts of the crosslinking agent, 0.24-0.28 parts of the oxidizing agent, 0.4-0.48 parts of the catalyst, 1.8-2.6 parts of the gelatinizing agent, 0.1-0.3 parts of the water retaining agent, 0.8-1.2 parts of the wetting agent, and the balance is distilled water. The dust suppressant can wet and penetrate into the gaps of coal dust particles, and water molecules form hydrogen bonds with hydrophilic groups in the crosslinked network structure, firmly adsorbed on the network structure, thereby improving the water retention performance of the solidified layer.

### CROSS-REFERENCE TO RELATED APPLICATIONS

This application claims priority to Chinese Application No. 202410550510.X, filed on May 6, 2024, entitled “A DUST SUPPRESSION MATERIAL WITH A CROSSLINKED NETWORK STRUCTURE AND ITS PREPARATION METHOD”. These contents are hereby incorporated by reference.

### TECHNICAL FIELD

The present disclosure relates to the field of dust suppression and control, particularly to a dust suppression material with a crosslinked network structure and its preparation method.

### BACKGROUND

Coal dust is one of the main problems in coal mining, and the current problem of the coal dust pollution is urgent and needs to be addressed. A large amount of dust will be generated during coal mining and transportation. The latest environmental pollution monitoring data shows that dust emissions and pollution result in a severe exceedance of PM_{2.5} and PM₁₀, resulting in serious harm to the environment. Dust not only seriously threatens the physical and mental health of the workers and residents around the mining area, but also causes explosions and pneumoconiosis. In addition, due to the fact that outdoor coal mines are mostly located in areas with dry soil, scarce water resources, and drought, the dust travel speed can reach 3-4 m/s or more. Small particles such as PM_{2.5} in the dust are not easy to settle and float hundreds of kilometers with the wind, further exacerbating the environmental risks. Moreover, the environment of the outdoor coal mines is complex. In the desert areas, the temperature in areas with direct sunlight can reach over 60° C., and at night the temperature may drop sharply to below −15° C., which requires high requirements for the anti-freezing and thawing properties of the dust suppressants.

In view of the problem of dust control in the outdoor coal mines, one of the most effective methods is to suppress dust by spraying, but the sprayed water is easy to evaporate, and needs to be sprayed again in a short time. At present, there are many materials for dust suppression by spraying, but for the complex outdoor coal mine environment with large rain erosion and temperature difference, the resistance of the solidified layer of general dust suppression materials is poor, leading to the unsustainable dust suppression effect.

Therefore, it is urgent to develop a weather resistant dust suppression material.

### SUMMARY

To solve the technical problem of the poor weather resistance of the solidified layer of the dust suppression materials in complex climates of the outdoor coal mines, the present disclosure discloses a dust suppression material and preparation method comprising low viscosity materials and a strong weather resistant crosslinked network structure in the complex environments.

The first aspect of the present disclosure proposes a dust suppression material with a crosslinked network structure, comprising: a cassava starch, a polyvinyl alcohol, a carboxymethyl cellulose, a crosslinking agent, an oxidizing agent, a catalyst, a gelatinizing agent, a water retaining agent, a wetting agent, and a distilled water.

Preferably, the dust suppression material with the crosslinked network structure in one aspect, comprising by weight:
16-20 parts of the cassava starch,
0.2-0.6 parts of the polyvinyl alcohol,
0.1-0.5 parts of the carboxymethyl cellulose,
0.1-0.5 parts of the crosslinking agent,
0.24-0.28 parts of the oxidizing agent,
0.4-0.48 parts of the catalyst,
1.8-2.6 parts of the gelatinizing agent,
0.1-0.3 parts of the water retaining agent,
0.8-1.2 parts of the wetting agent, and
the balance is distilled water.

The cassava starch is an environmentally friendly and natural polysaccharide that is inexpensive and easily available, which is used as a dust suppression raw material, and can provide a crosslinked network skeleton and is easily biodegradable.

The polyvinyl alcohol is an organic compound with multiple hydroxyl groups in its chain structure, which has good film-forming and biodegradability properties. It has a structure similar to starch, so it is compatible well with starch. In order to enhance the curing strength of the dust suppressants, polyvinyl alcohol is combined with other materials to prepare the materials with a crosslinked network.

The carboxymethyl cellulose has high solubility and stability, and exhibits high stability over a wide range of temperatures and pH, making it a reinforcing agent for the dust suppression materials.

Preferably, the crosslinking agent is glutaraldehyde, the oxidizing agent is hydrogen peroxide, the catalyst is copper sulfate, the gelatinizing agent is sodium hydroxide, and the water retaining agent is glycerol.

The glutaraldehyde is an important crosslinking agent with wide applications in materials, chemical and other fields, with a good crosslinking effect and stability.

The copper sulfate is used as a catalyst, and the efficiency of metal ion catalysts commonly used in oxidation processes can be ranked as follows: Cu>Fe>WO₄.

The hydrogen peroxide is the most common oxidizing agent, which ultimately decomposes into oxygen and water during the oxidation process, making it environmentally friendly.

Glycerol, as a water retention auxiliary material, can prevent the curing film from drying and cracking.

Preferably, the wetting agent is fatty alcohol polyoxyethylene ether sodium sulfate and alkyl glucoside, with a mass ratio of 2:3. Fatty alcohol polyoxyethylene ether sodium sulfate and alkyl glycosides are used as wetting agents. Fatty alcohol polyoxyethylene ether sodium sulfate is an anionic surfactant that is easily soluble in water. Alkyl glycosides have low surface tension, strong wetting ability, and good penetration effect. It is usually compounded with other surfactants to achieve synergistic effects.

The second aspect of the present disclosure proposes a method for preparing the above-mentioned dust suppression material, comprising:
adding the distilled water and the cassava starch to a beaker, and stirring for 10 minutes to make a uniform suspension, adding the crosslinking agent and heating to 50° C., and then heating in a water bath for 1 hour to obtain a mixture I;
adding the catalyst and the oxidizing agent to the mixture I, mixing thoroughly, and standing for 30 minutes for catalytic oxidation; adding the dissolved gelatinizing agent into the beaker containing the oxidized crosslinked starch and stirring again, standing for 24 hours to obtain a mixture II;
adding the polyvinyl alcohol and the distilled water to the beaker, heating to 95° C. until the polyvinyl alcohol is completely dissolved, then cooling down and adding the diluted mixture II, the carboxymethyl cellulose, and the water retaining agent, and mixing thoroughly, and heating in a water bath for 1 hour to obtain a mixture III;
cooling the mixture III to room temperature, adjusting the pH of the solution, adding the wetting agent to the mixture III, to obtain a dust suppression solution with the crosslinked network structure.

Preferably, the crosslinking agent is glutaraldehyde, the oxidizing agent is hydrogen peroxide, the catalyst is copper sulfate, the gelatinizing agent is sodium hydroxide, and the water retaining agent is glycerol.

Preferably, the wetting agent is fatty alcohol polyoxyethylene ether sodium sulfate and alkyl glucoside, with a mass ratio of 2:3.

The reaction process of the present disclosure is as follows:

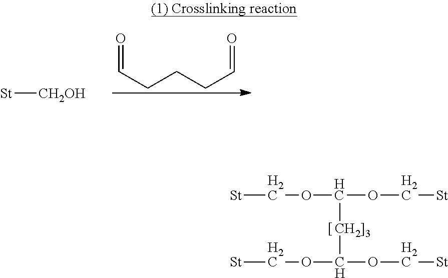

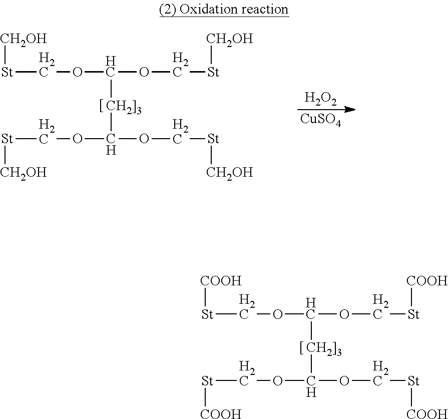

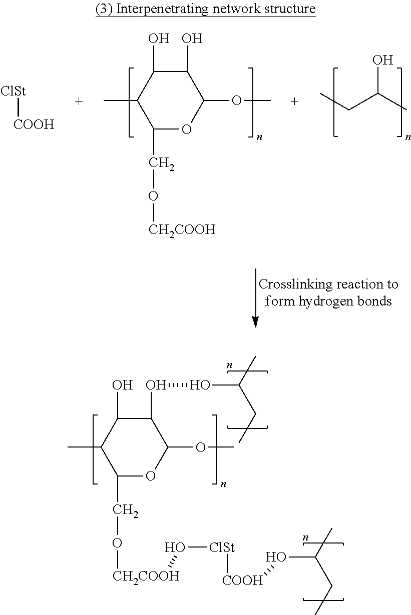

St-CH₂OH is used to represent starch, and the starch molecules contain multiple hydroxyl groups. CLSt-COOH is used to represent the oxidized crosslinked starch, and during the oxidation process, there may be weaker hydroxyl groups that are not completely oxidized. Therefore, the product of step (3) contains the form of HO-CLSt-COOH.

The reaction principle of the present disclosure is:
(1) The aldehyde group in glutaraldehyde molecules undergoes an etherification crosslinking reaction with the hydroxyl group on the cassava starch molecules, and the newly generated chemical bonds continuously replace the original hydrogen bonds on the original molecular chain, forming a tightly crosslinked network structure of cassava starch.
(2) The crosslinked cassava starch undergoes an oxidation reaction with the hydrogen oxide, and further oxidizes some of the active hydroxyl groups in the crosslinked starch molecules into carboxyl groups. At the same time, the oxidation reaction breaks the glycosidic chain, resulting in partial degradation of starch molecules and a decrease in molecular weight.
(3) The oxidized crosslinked starch is used as the skeleton, and polyvinyl alcohol-oxidized crosslinked starch-carboxymethyl cellulose is connected by hydrogen bonds. The molecular chains are intertwined and crosslinked to form an interpenetrating network structure, ultimately forming a three-dimensional hydrogen bond network structure with water and surfactants.

The third aspect of the present disclosure proposes a use of the above-mentioned dust suppression material for dust control in complex outdoor environments.

Compared to existing technologies, the advantageous effects of the present disclosure are:
(1) The cassava starch is modified by crosslinking first and then oxidizing in the present disclosure, thereby avoiding excessive consumption of hydroxyl groups by oxidation reactions and reducing crosslinking degree. The aldehyde group in glutaraldehyde molecules undergoes an etherification crosslinking reaction with the hydroxyl group on cassava starch molecules, and the newly generated chemical bonds continuously replace the original hydrogen bonds on the original molecular chain. The resulting cassava starch has a tight and firm crosslinking network structure because of the crosslinking bonds, increasing the strength and cohesion of the cassava crosslinked starch.
(2) The crosslinked cassava starch is oxidized by hydrogen peroxide, which further oxidizes some of the active hydroxyl groups in the crosslinked starch molecules into carboxyl groups. At the same time, the oxidation reaction results in the glycosidic chain to break, reducing the viscosity of the starch and improving its fluidity and water resistance.
(3) The modified starch is copolymerized with polyvinyl alcohol and carboxymethyl cellulose, and then compounded with fatty alcohol polyoxyethylene ether sodium sulfate (AES) and alkyl glucoside (APG-0810) to obtain a low-cost and biodegradable dust suppression material.
(4) After sprayed on the coal dust, the dust suppressant produced by the present disclosure can wet and penetrate into the gaps of the coal dust particles. The water molecules form hydrogen bonds with hydrophilic groups in the crosslinked network structure, firmly adsorbed on the network structure, thereby improving the water retention performance of the solidified layer. Moreover, the crosslinked network structure improves the agglomeration effect between the coal dust particles, forming a smooth and dense solidified layer. Glycerol can retain a certain amount of moisture in the solidified layer to prevent cracking.
(5) The dust suppressant produced by the present disclosure can effectively suppress dust in weather conditions such as rain erosion and high or low temperatures, and the solidified layer remains intact after washed and soaked for 24 hours. It can adapt to temperature changes of −18-60° C. and has a water retention performance 40.0% higher than water. The weather resistance of dust suppressants such as high temperature resistance, freeze-thaw resistance, and rain erosion resistance has been enhanced while the wetting property is improved, providing a feasible solution for the application of chemical dust suppressants in dust control in complex outdoor environments.

### BRIEF DESCRIPTION OF THE DRAWINGS

FIG. 1 is a flowchart of the preparation method of the dust suppression material with the crosslinked network structure according to the present disclosure.

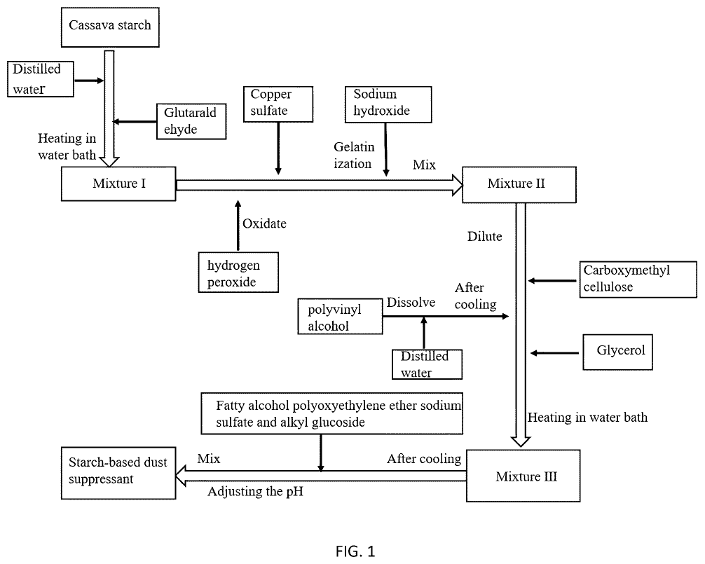

### DETAILED DESCRIPTION OF THE EMBODIMENTS

The present invention will be further described with reference to the drawings and preferred embodiments. It should be understood that these embodiments are only used to illustrate the present invention, but the present invention is not limited thereto. In addition, it should be understood that after reading the content described in the present invention, those skilled in the art can make various changes or modifications to the present invention, and these equivalent technical means also fall within the scope of protection of the present invention.

The present disclosure discloses a dust suppression material comprising low viscosity materials and a strong weather resistant crosslinked network structure in complex environments. The raw materials used include 16-20 parts of a cassava starch, 0.2-0.6 parts of a polyvinyl alcohol, 0.1-0.5 parts of a carboxymethyl cellulose, 0.1-0.5 parts of a crosslinking agent, 0.24-0.28 parts of an oxidizing agent, 0.4-0.48 parts of a catalyst, 1.8-2.6 parts of a gelatinizing agent, 0.1-0.3 parts of a water retaining agent, 0.8-1.2 parts of a wetting agent, and the balance is distilled water.

### Example 1

A method for preparing a dust suppression material with a crosslinked network structure, comprising the following steps:
(1) adding 100 ml of distilled water and 16 g of cassava starch to a beaker, and stirring for 10 minutes to make a uniform suspension, then adding 0.1 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.2 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 60° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 2

A method for preparing a dust suppression material with a crosslinked network structure, comprising the following steps:
(1) adding 100 ml of distilled water and 16 g of cassava starch to a beaker, and stirring for 10 minutes to make a uniform suspension, then adding 0.5 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.4 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 65° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 3

A method for preparing a dust suppression material with a crosslinked network structure, comprising the following steps:
(1) adding 100 ml of distilled water and 16 g of cassava starch to a beaker, and stirring for 10 minutes to make a uniform suspension, then adding 0.3 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.6 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 70° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 4

A method for preparing a dust suppression material with a crosslinked network structure, comprising the following steps:
(1) adding 100 ml of distilled water and 18 g of cassava starch to a beaker, and stirring for 10 minutes to make a uniform suspension, then adding 0.5 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.2 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 70° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 5

A method for preparing a dust suppression material with a crosslinked network structure, comprising the following steps:
(1) adding 100 ml of distilled water and 18 g of cassava starch to a beaker, and stirring for 10 minutes to make a uniform suspension, then adding 0.3 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.4 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 60° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 6

A method for preparing a dust suppression material with a crosslinked network structure, comprising the following steps:
(1) adding 100 ml of distilled water and 18 g of cassava starch to a beaker, and stirring for 10 minutes to make a uniform suspension, then adding 0.1 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.6 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 65° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 7

A method for preparing a dust suppression material with a crosslinked network structure, comprising the following steps:
(1) adding 100 ml of distilled water and 20 g of cassava starch to a beaker, and stirring for 10 minutes to make a uniform suspension, then adding 0.3 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.2 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 65° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 8

A method for preparing a dust suppression material with a crosslinked network structure, comprising the following steps:
(1) adding 100 ml of distilled water and 20 g of cassava starch to a beaker, and stirring for 10 minutes to make a uniform suspension, then adding 0.1 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.4 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 70° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Example 9

A method for preparing a dust suppression material with a crosslinked network structure, comprising the following steps:
(1) adding 100 ml of distilled water and 20 g of cassava starch to a beaker, and stirring for 10 minutes to make a uniform suspension, then adding 0.5 g of glutaraldehyde, heating to 50° C. in a water bath for 1 hour, to obtain mixture I;
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours to obtain mixture II;
(3) adding 0.6 g of polyvinyl alcohol and 95 ml of distilled water to a beaker, heating up to 95° C. until the polyvinyl alcohol is completely dissolved, and then cooling down; adding 5 ml of diluted mixture II, 0.3 g of carboxymethyl cellulose, and 0.2 g of glycerol, mixing thoroughly, and heating to 60° C. in a water bath for 1 hour to obtain a mixture III;
(4) cooling the mixture III to room temperature, adjusting the pH of the solution and adding 1 g of fatty alcohol polyoxyethylene ether sodium sulfate and alkyl polyglycosides with a mass ratio of 2:3, then stirring to dissolve and prepare the dust suppressant with the crosslinked network structure which can be used in the complex environment.

### Comparative Example 1

(1) adding 100 ml of distilled water and 18 g of cassava starch to a beaker, and stirring for 10 minutes to make a uniform suspension, then adding 0.3 g of glutaraldehyde, heating to 50° C. in a water bath for 1 hour, to obtain mixture I.
(2) adding 0.44 g of copper sulfate and 0.86 ml of hydrogen peroxide to mixture I, mixing thoroughly, and standing for 30 minutes for catalytic oxidation; adding 20 ml of distilled water and 2 g of sodium hydroxide to a beaker, then adding slowly to the beaker containing the oxidized crosslinked starch and stirring again, standing for 24 hours and diluting 10 times; and taking the diluted solution and adding 1 g of fatty alcohol polyoxyethylene ether sodium sulfate and alkyl glucoside with a mass ratio of 2:3, stirring to dissolve.

### Comparative Example 2

Adding 0.4 g of polyvinyl alcohol and 100 ml of distilled water to a beaker, heating up to 95° C. until the polyvinyl alcohol is completely dissolved, then cooling down, and adding 1 g of fatty alcohol polyoxyethylene ether sodium sulfate and alkyl glucoside with a mass ratio of 2:3, stirring to dissolve.

The effectiveness of examples 1-9 and comparative examples 1 and 2 are evaluated by testing. The following experiments were conducted in accordance with the TB/T3210.1-2020 standard for coal sample preparation, using a standard sieve to screen 200 mesh coal samples. The samples are Dried in a drying oven at (50±2) ° C. for 5 hours to remove moisture, then taken out and left at room temperature for 1 hour.

### Test 1

The dust suppressant with the crosslinked network structure which can be used in the complex environments prepared in Examples 1-9, as well as Comparative Examples 1 and 2, will be tested for their freeze-thaw resistance and rain erosion resistance.

The test method is: putting the same amount of pulverized coal in multiple Petri dishes, and adding 9 samples of Examples 1-9 and 2 samples of Comparative examples 1 and 2 with the same mass on the coal dust surface; placing the Petri dishes in a drying oven at 60° C. and heating for 12 hours; taking the Petri dishes out and freezing in a refrigerator for 12 hours at a low temperature of −18° C.; heating and freezing for 3 times, and comparing the hardness values obtained after freeze-thaw with the initial values, and calculating the hardness loss rate.

Using a rain erosion simulation experimental platform, spraying at a rate of 10 ml/s at a distance of 0.5 m from the sample for 3 minutes, observing the surface condition of the solidified layer, and weighing after dried again to calculate the mass loss rate.

The test results are shown in Table 1 below.

TABLE 1
freeze-thaw resistance and rain erosion resistance tests

| | Cumulative hardness loss rate (%) | | Mass loss rate (%) |
|---|---|---|---|
| Experimental | High temperature | Low temperature | Simulated rain |
| samples | (60° C.) | (−18° C.) | erosion |
| Example 1 | 8.35 | 9.02 | 25.45 |
| Example 2 | 8.2 | 8.27 | 23.23 |
| Example 3 | 6.78 | 7.44 | 23.27 |
| Example 4 | 8.12 | 7.54 | 21.45 |
| Example 5 | 6.17 | 6.89 | 19.86 |
| Example 6 | 6.23 | 7.34 | 22.40 |
| Example 7 | 7.79 | 5.98 | 25.31 |
| Example 8 | 8.24 | 8.27 | 24.67 |
| Example 9 | 7.65 | 6.73 | 26.57 |
| Comparative | 21.12 | 19.25 | 70.21 |
| example 1 | | | |
| Comparative | 16.31 | 14.45 | 53.23 |
| example 2 | | | |

Analyzing the results of Test 1, compared with Comparative Examples 1 and 2, the temperature changes in Examples 1-9 have a smaller impact on the hardness of the solidified layer. This indicates that the solidified layer is relatively stable during the temperature changes of −18-60° C., and can meet the requirements of freeze-thaw resistance in the complex outdoor environments. After washed away by rainwater, the mass loss rate of Example 5 was only 19.86% with a good dust suppression performance, indicating that the solidified layer has good anti-interference performance and good rain erosion resistance.

### Test 2

The dust suppressant with the crosslinked network structure which can be used in the complex environments prepared in Examples 1-9, as well as Comparative Examples 1 and 2, will be tested for the wetting and water retention.

The test method is as follows: putting the same amount of pulverized coal in multiple Petri dishes, and adding 9 samples of Examples 1-9 and 2 samples of Comparative examples 1 and 2 with the same mass on the coal dust surface; placing the Petri dishes in a drying oven at 50° C.; taking the Petri dishes out 2 hours later and weighting; and calculating the cumulative evaporation rate of the dust suppressant.

Putting the coal cake on the sample stage of the contact angle measuring instrument, adjusting the surface to horizontal, and creating droplets on the surface of the coal cake to be measured through a syringe. The droplets will come into contact with the surface of the coal cake to be measured, and the contact angles are recorded at 0-2 seconds.

The test results are shown in Table 2 below.

TABLE 2
Water retention and wettability tests

| Experimental | Cumulative evaporation rate (%) | | | | | Contact angle (°) | | |
|---|---|---|---|---|---|---|---|---|
| samples | 1 h | 2 h | 3 h | 4 h | 5 h | 0 s | 1 s | 2 s |
| Example 1 | 23.45 | 45.03 | 61.53 | 77.32 | 85.67 | 30.93 | 12.45 | 10.63 |
| Example 2 | 24.38 | 45.76 | 63.79 | 76.59 | 85.79 | 29.78 | 11.56 | 10.34 |
| Example 3 | 23.15 | 44.80 | 59.92 | 77.89 | 85.42 | 29.54 | 12.75 | 10.98 |
| Example 4 | 22.76 | 43.93 | 60.37 | 76.04 | 84.76 | 30.72 | 12.72 | 9.67 |
| Example 5 | 22.12 | 43.24 | 59.67 | 75.68 | 83.22 | 28.66 | 12.13 | 9.32 |
| Example 6 | 23.97 | 44.17 | 60.74 | 76.34 | 84.91 | 29.34 | 12.73 | 10.04 |
| Example 7 | 21.94 | 42.86 | 61.02 | 74.57 | 82.10 | 28.42 | 11.29 | 9.95 |
| Example 8 | 22.32 | 43.59 | 60.87 | 75.61 | 83.59 | 31.47 | 12.76 | 11.54 |
| Example 9 | 23.17 | 42.63 | 59.85 | 76.52 | 83.51 | 30.19 | 12.46 | 10.86 |
| Comparative | 27.46 | 52.31 | 73.68 | 89.25 | 96.35 | 47.81 | 25.73 | 20.79 |
| example 1 | | | | | | | | |
| Comparative | 28.13 | 50.87 | 72.63 | 92.53 | 97.32 | 39.24 | 22.15 | 19.87 |
| example 2 | | | | | | | | |

Based on the analysis of the results of Test 2, it can be concluded from the dynamic changes in contact angles that Examples 4, 5, and 7 have better wetting effect, because of the low viscosity of the materials and the presence of hydrophilic groups such as hydroxyl groups in their molecular structure. After 5 hours of drying, the cumulative evaporation rate of Comparative Examples 1 and 2 reached over 9500, while the dust suppression material in the examples 1-9 formed a dense solidification layer after solidification, which could maintain a certain amount of moisture and had good water retention performance.

From above, it can be seen that the present disclosure can evaluate the actual dust suppression effect of the dust suppression material by using different ratios and testing its freeze-thaw resistance, rain erosion resistance, water retention, and wettability.

In summary, the dust suppressant produced by the present disclosure can effectively suppress the dust even under weather conditions such as rain erosion and high low temperatures. It can solve the technical problem of intolerance of the solidified layer of the dust suppressant materials in complex weather conditions of the outdoor coal mines and has good social and considerable economic benefits.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. A dust suppression material with a crosslinked network structure, comprising: a cassava starch, a polyvinyl alcohol, a carboxymethyl cellulose, a crosslinking agent, an oxidizing agent, a catalyst, a gelatinizing agent, a water retaining agent, a wetting agent, and a distilled water.

2. The dust suppression material with the crosslinked network structure according to claim 1, comprising by weight:
16-20 parts of the cassava starch,
0.2-0.6 parts of the polyvinyl alcohol,
0.1-0.5 parts of the carboxymethyl cellulose,
0.1-0.5 parts of the crosslinking agent,
0.24-0.28 parts of the oxidizing agent,
0.4-0.48 parts of the catalyst,
1.8-2.6 parts of the gelatinizing agent,
0.1-0.3 parts of the water retaining agent,
0.8-1.2 parts of the wetting agent, and
the balance is distilled water.

3. The dust suppression material with the crosslinked network structure according to claim 2, wherein the crosslinking agent is glutaraldehyde, the oxidizing agent is hydrogen peroxide, the catalyst is copper sulfate, the gelatinizing agent is sodium hydroxide, and the water retaining agent is glycerol.

4. The dust suppression material with the crosslinked network structure according to claim 3, wherein the wetting agent is fatty alcohol polyoxyethylene ether sodium sulfate and alkyl glucoside, with a mass ratio of 2:3.

5. A method for preparing the dust suppression material with the crosslinked network structure according to claim 1, comprising:
adding the distilled water and the cassava starch to a beaker, and stirring for 10 minutes to make a uniform suspension, adding the crosslinking agent and heating to 50° C., and then heating in a water bath for 1 hour to obtain a mixture I;
adding the catalyst and the oxidizing agent to the mixture I, mixing thoroughly, and standing for 30 minutes for catalytic oxidation; adding the dissolved gelatinizing agent into the beaker containing the oxidized crosslinked starch and stirring again, standing for 24 hours to obtain a mixture II;
adding the polyvinyl alcohol and the distilled water to the beaker, heating to 95° C. until the polyvinyl alcohol is completely dissolved, then cooling down and adding the diluted mixture II, the carboxymethyl cellulose, and the water retaining agent, and mixing thoroughly, and heating in a water bath for 1 hour to obtain a mixture III;
cooling the mixture III to room temperature, adjusting the pH of the solution, adding the wetting agent to the mixture III, to obtain a dust suppression solution with the crosslinked network structure.

6. The method according to claim 5, wherein the crosslinking agent is glutaraldehyde, the oxidizing agent is hydrogen peroxide, the catalyst is copper sulfate, the gelatinizing agent is sodium hydroxide, and the water retaining agent is glycerol.

7. The method according to claim 5, wherein the wetting agent is fatty alcohol polyoxyethylene ether sodium sulfate and alkyl glucoside, with a mass ratio of 2:3.

8. The method according to claim 5, wherein the dust suppression material is used for dust control in outdoor environments.
